(19) United States
(12) Patent Application Publication
(10) Pub. No.: US 2009/0200050 A1
(43) Pub. Date: Aug. 13, 2009

(54) AERATING DEVICE

(75) Inventor: Anton Cornelis Bos, Doorn (NL)

Correspondence Address: KNOBBE MARTENS OLSON & BEAR LLP, 2040 MAIN STREET, FOURTEENTH FLOOR, IRVINE, CA, 92614, US

(73) Assignee: REDEXIM HANDEL-EN EXPLOITATIE MAATSCHAPPIJ B.V., AC Zeist (NL)

(21) Appl. No.: 12/296,890

(22) PCT Filed: Apr. 5, 2007
(86) PCT No.: PCT/NL2007/000096

§ 371 Date: Mar. 13, 2009

(30) Foreign Application Priority Data
Apr. 11, 2006 (NL) 1031566

(51) Int. Cl. A01B 45/02; A01B 79/00

(52) U.S. Cl. 172/21; 172/1

(57) ABSTRACT

The invention relates to a device for aerating a ground, comprising a frame (2) provided with moving means (4) for travel of the device over a ground, a crankshaft (14) which is bearing mounted on the frame (2) and which can be coupled to a drive, a number of aerating means (21-23) connected to the frame (2) and connected to the crankshaft (14), wherein the aerating means (21-23) comprises at least one pin (45) which is adapted to perform a repetitive movement in a situation of use, wherein the pin (45) is inserted into the ground, wherein the movement is guided by at least two pivoting arms (24, 40) of the aerating means (21-23). The invention is characterized in that at least a first arm (40) of the aerating means (21-23) has a pivot point (44) which is movable relative to the frame (2) in the situation of use.

The invention relates to a device for aerating a ground, comprising a frame provided with moving means for travel of the device over the ground. A crankshaft is preferably bearing mounted on the frame. The crankshaft can be coupled to a drive. The device preferably further comprises a number of aerating means connected to the frame and connected to the crankshaft. The aerating means preferably comprises at least one pin. The aerating means is adapted to perform a repetitive movement with the pin in a situation of use, wherein the pin is inserted into the ground, whereby the pin brings about aeration of this ground. The aerating means preferably further comprises two pivoting arms which guide the repetitive movement.

An aerating device is for instance known from DE 43 33 310. The known device has a drive for the aerating means which comprises a number of arms, wherein these arms can pivot and perform a repetitive movement.

It is also known that displacement of the pivot point of one of the arms of the aerating means can result in a different insertion angle of the pin into the ground. The pivot point is displaced when the device is not in use, and is fixed at the new position. The repetitive movement is then performed around the adjusted, though fixed pivot point.

According to the prior art one of the arms of the aerating means is for instance embodied as a telescopic arm provided with a spring means for extending this arm, whereby the pin guided into the ground can pivot relative to said system of the arms. A pivoting and aerating operation is hereby achieved.

A problem in the known telescopic arm is the wear of this telescopic arm, and in particular breaking thereof. This results in high maintenance costs. The object of the invention is to provide a device wherein the maintenance costs can be reduced.

According to one aspect of the invention, this object is achieved in that at least a first arm of the aerating means has a pivot point which is movable relative to the frame in the situation of use. In the position of use the arm pivots around the pivot point. In contrast to the prior art devices, the first arm does not pivot around a point which is connected non-releasably or releasably to the frame while performing the repetitive movement, but this pivot point is movable. The first arm can hereby be embodied as a non-releasable or releasable arm. This enables an extension of this arm comparable to that of the telescopic arm in that the pivot point is displaced. Due to the displaceable pivot point it is possible to do without the telescopic arm and the maintenance costs associated with the telescopic arm.

In a preferred embodiment the pivot point of the first arm is connected to the frame by means of a suspension. The suspension enables a movement of the pivot point in the situation of use. The suspension point or pivot point is here the point around which the arm moves, driven by the crankshaft for the purpose of performing the repetitive movement of the pin. The invention deviates from the principle developed in the prior art of a fixed pivot point not movable relative to the frame in the situation of use, and replaces this with a movable pivot point, whereby the telescopic arm becomes unnecessary.

The suspension is a guide means for guiding the movement of the pivot point in the position of use.

The pivot point is preferably arranged on a free outer end of the first arm. In the prior art this free end was fixedly connected to the frame via a determined coupling so that this pivot point is fixed in the situation of use.

It is further recommended that the suspension comprises at least one third arm which is connected to the pivot point of the first arm. The connection of the third arm to the first arm forms the suspension point of the first arm, and according to the invention this suspension point is displaceable in the situation of use. The suspension enables a movement of the third arm, and thereby a movement of the suspension point of the first arm.

The third arm can for instance be a guided arm, for instance in a guide path or in a carriage, and in one embodiment can be a telescopic arm. Because different forms are possible for the third arm and because the third arm does not lie in line with the first arm, more options are available for extending the first arm, in contrast to the prior art wherein the telescopic arm is used as first arm. When the third arm is a telescopic arm, the direction of displacement of the pivot point/suspension point can be guided in a determined path by his telescopic arm.

In another embodiment the third arm is a pivoting arm, whereby the suspension point can be moved according to a circular path in the situation of use.

In the preferred embodiment the suspension comprises biasing means for positioning the pivot point/suspension point of the first arm in a starting position. The biasing means are adapted to urge the pivot point to a determined starting position and to force the pivot point to the starting position when it deviates from this starting position. In an embodiment the biasing means is a spring means. Different biasing means can be used simultaneously.

In an advantageous embodiment the biasing means is a torsion spring. The torsion spring can for instance be coupled to the third arm. The third arm is held in a starting position but can pivot around the rotation point of the torsion spring, whereby the suspension point can displace. The torsion spring will always urge the arm, and thereby the suspension point, back to the starting position.

In another embodiment the suspension comprises a “rosta” block. A rosta block is a commercially available product comprising a metal casing, preferably of a beam-like cross-section wherein a second rod is accommodated in the metal casing, wherein the metal rod is clamped between rubber elements which are for instance arranged in the corners of the first rod. The second rod can hereby rotate torsionally and is urged back in each case to the starting position by the rubber elements. Such a rosta block has very low maintenance costs. There are no parts which scrape against each other. Replacement of the telescopic arm, which is susceptible to maintenance, is possible by making the suspension point displaceable in the situation of use and suspending it via a rosta block.

In a further preferred embodiment the suspension comprises a stop connected to the frame. The stop can support on the first arm. The first arm can hereby not move in a determined direction blocked by the stop, and is thus limited in its freedom of movement, particularly in the situation of use. The stop forms a contact point for the first or third arm. The freedom of movement of the pivot point/suspension point of the arm can hereby for instance be limited.

It is also advantageous to connect the stop to the frame in spring-mounted manner or to compose the stop of an elastic material. The impulse of the first arm, which is urged back against the stop by the spring means or the biasing means to the starting position, can hereby be absorbed and at least a part of the energy can dissipate via a non-elastic collision. In another embodiment the stop comprises a damper.

It is further advantageous that the position of the stop is adjustable relative to the frame. The stop can be moved and fixed at a position. Owing to this adjustability the contact point of the arm on the stop can be adjusted, and the position of the pivot point/suspension point can thus be changed. The starting position of the pivot point, i.e. the position of the pivot point/suspension point in which the aerating means is not loaded, so at rest, can hereby be adjusted. The insertion angle of the pin into the ground can for instance be adapted due to this adjustability.

The means for adjusting the position of the stop is preferably an eccentric rotating rod which is pivotally connected to the frame. The adjusting means pushes the stop into a position. The stop is for instance received in a guide bush. The stop line lies against an outer end of the pivoting first arm. The adjusting means can push the stop aside by the adjusting means being rotated around the eccentric shaft, thereby bringing about displacing of the stop. In particular, a plurality of stops can hereby be moved and adjusted simultaneously, whereby the angular adjustment of the pins of the aerating means is achieved for all aerating means in one operation.

It is further recommended that the spring means, such as the biasing means or the rosta block, are adapted to exert a spring force on the pivot point in the direction of the stop. The pivot point/suspension point is hereby biased in the direction of the stop and forced against the stop each time the pivot point has moved in the situation of use. The pivot point is hereby always returned to the starting position. The repetitive movement is hereby always started in the same way, in particular during insertion of the pin into the ground.

In a further embodiment the suspension connects a number of first arms of the aerating means to the frame. The aerating means are connected to the frame by means of a shared suspension. The pivot points of these first arms are herein movable relative to the frame in the situation of use. Because one suspension is used, the starting position and/or the bias applied by the suspension on the pivot point/suspension point can be set or adjusted simultaneously for all aerating means. This enables a particularly simple adjustment of the force which allows displacement of the pivot point. According to the prior art the spring force which was allowed in the telescopic arm had to be adjusted each time per telescopic arm and aerating means, while a central adjustment of this force is now possible according to the invention via the shared suspension.

The shared setting of the force is preferably obtained by means of a unit which connects the various third arms of the suspension to the frame, wherein this unit is connected movably to the frame. The force required to displace the pivot point is adjusted by moving the unit. The unit is preferably a carriage. In one embodiment the carriage moves around a circular path. It is hereby possible for the position of the suspension point not to change, since the carriage moves around the centre, the pivot point, while the biasing force on the pivot point does change. The suspension co-acts particularly with the stop.

The second arm of the aerating means preferably has a pivot point which is fixedly connected to the frame. The second arm will hereby perform the same pivoting movement each time, while the first arm has a variable pivot point. Should the pin have to pivot relative to the guiding system of first and second arm, this then takes place through displacing of the pivot point of the first arm.

The first arm and second arm are preferably connected to a pin holder for a plurality of pins. The first and second arm are preferably connected pivotally to the pin holder.

A fourth arm preferably connects the crankshaft to the aerating means, wherein the fourth arm is connected pivotally to both the crankshaft and to one arm of the aerating means. The fourth arm is preferably connected to the second arm.

The invention is described here on the basis of a first aspect. A number of inventions are however stated in the description. The measures in question can be applied separately of the invention according to the first aspect. An example of a second invention is the use of a stop for the displacement of the pivot point. Further inventions are indicated in the text on the basis of stated advantages, although features are also stated without explicitly mentioning the advantages thereof. It is possible to file a divisional application relating to one of those inventions or combination of measures.

The invention will now be further described with reference to the accompanying figures, in which:

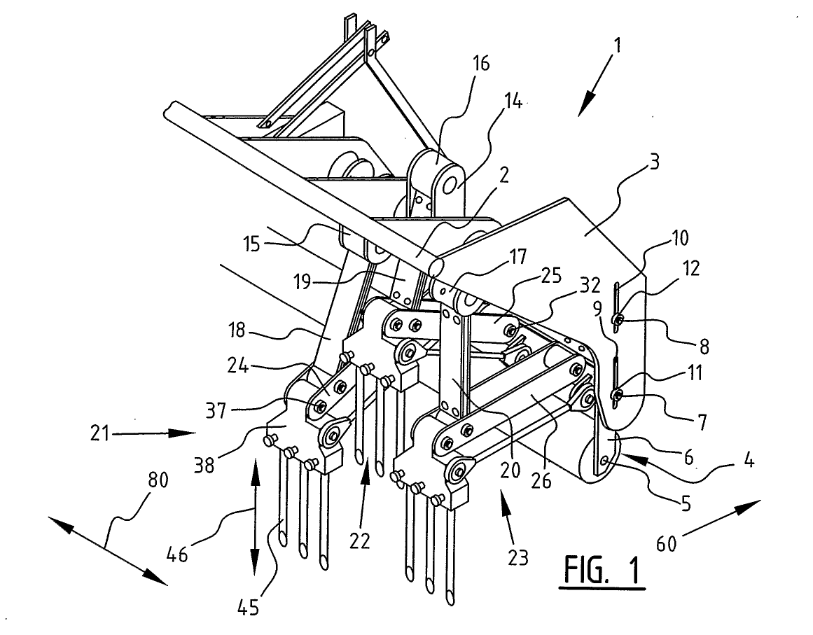

FIG. 1 shows a perspective view of an aerating device according to the invention,

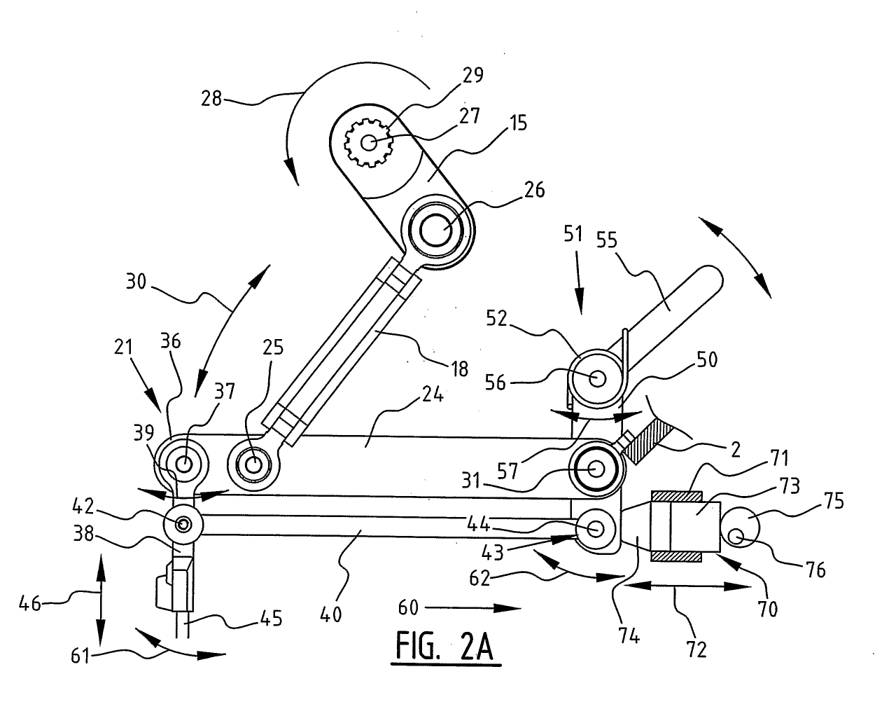

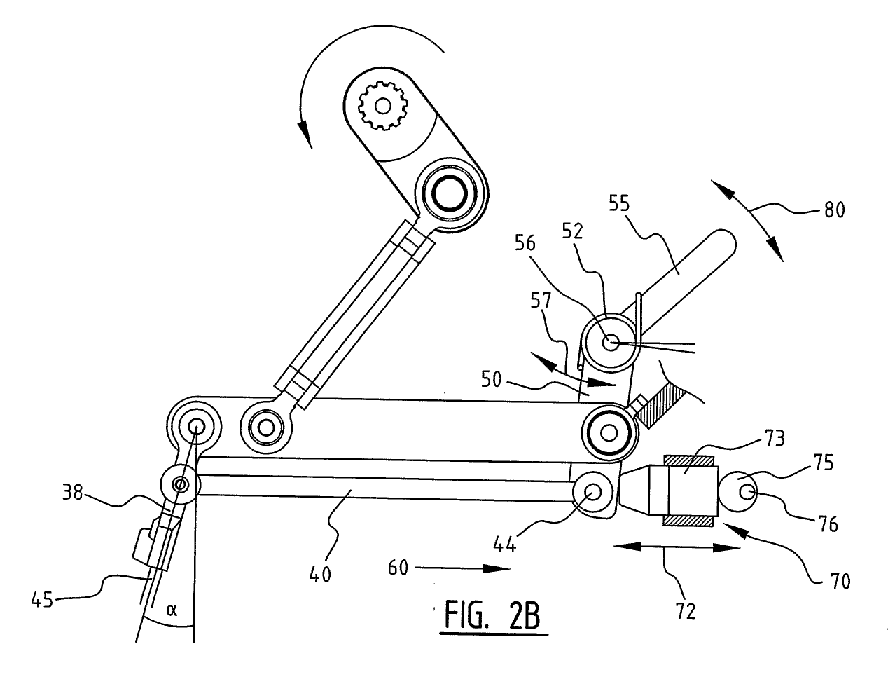

FIGS. 2a-2b show a first embodiment of an aerating means according to the invention,

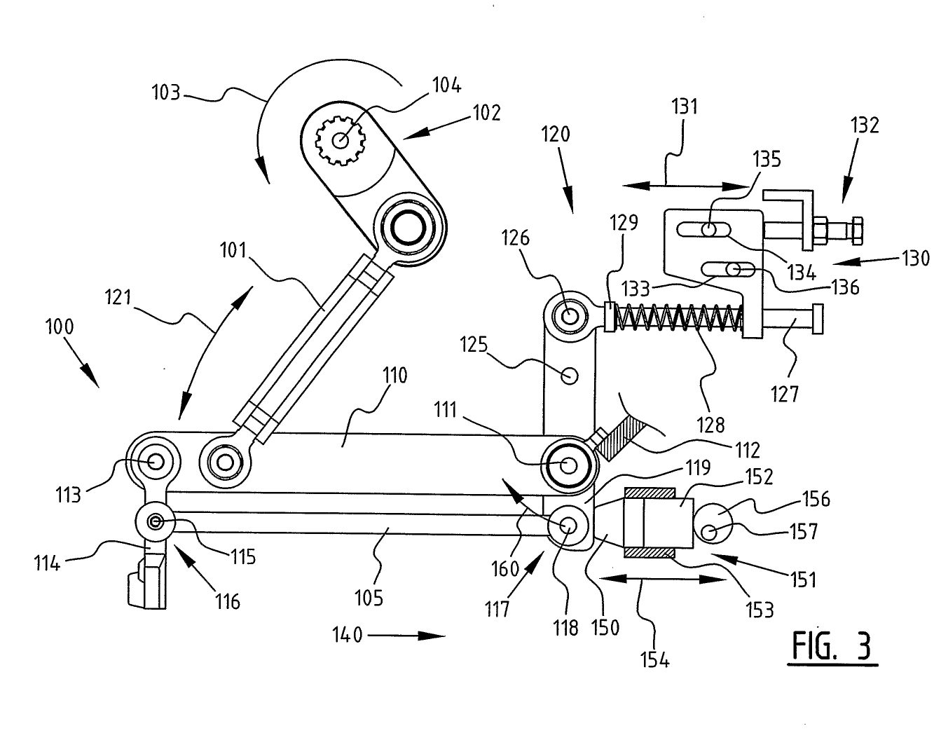

FIG. 3 shows a second embodiment of an aerating means according to the invention,

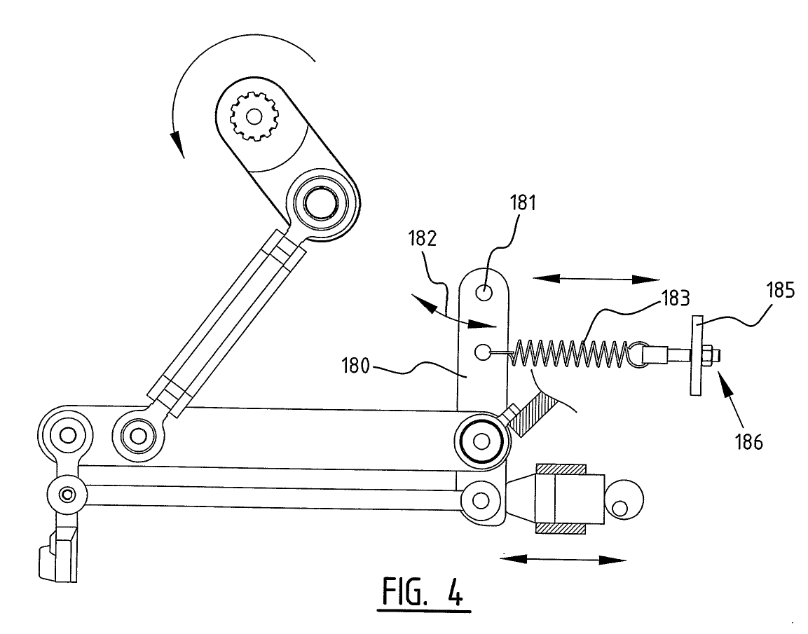

FIG. 4 shows a third embodiment of an aerating means according to the invention,

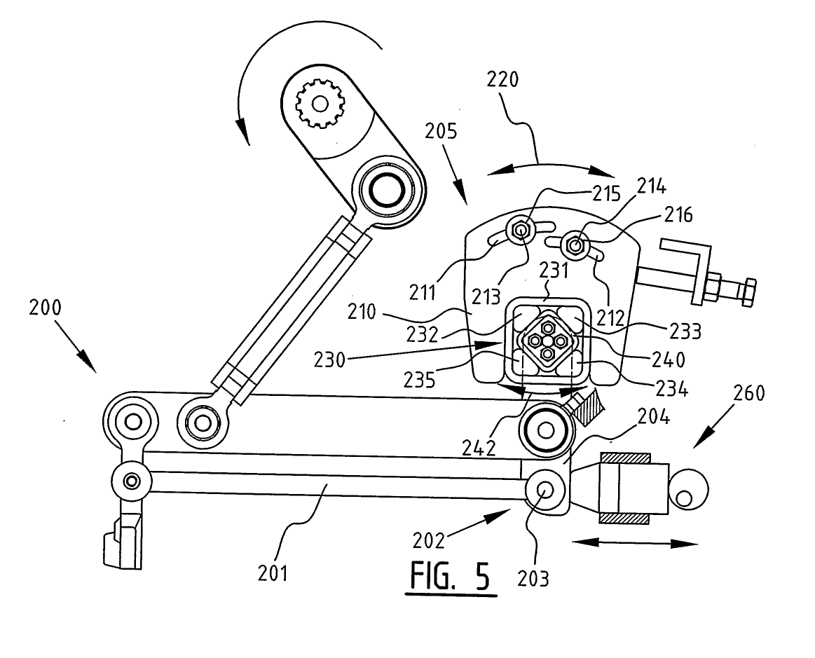

FIG. 5 shows a fourth embodiment of an aerating means according to the invention.

FIG. 1 shows a perspective view of an aerating device according to the invention. Aerating device 1 comprises a frame 2. The frame has a side wall 3, one of which is shown. Device 1 is pulled by for instance a tractor (not shown) which pulls the aerating device over a ground surface. In another embodiment the aerating device 1 is self-propelled.

Frame 2 is provided with a moving means 4, embodied as a roller, which is connected to the frame via a bearing 5. Bearing 5 is arranged on an arm 6, which is connected adjustably to frame 2. Arm 6 is provided with two pins 7,8 which protrude through slots 9,10 in side wall 3, wherein bolts 11,12 are arranged on the end of the pins. The pins and bolts together form a height adjustment for moving means 4. By loosening the bolts and causing the pin to protrude through the slots at a different position, the height of the aerating device above the ground can be adjusted in that the distance from roller 4 is increased.

Device 1 further comprises a crankshaft 14. Crankshaft 14 can be coupled to a drive (not shown). The coupling can be formed by means of a belt. The drive can be situated on the tractor. It can be transmitted to the releasable aerating device 1 via a coupling rod. The skilled person will be familiar with different embodiments for coupling the crankshaft to a drive.

Crankshaft 14 comprises a number of hinges 15-17 connecting an arm 18-20 to respective aerating means 21-23. Arms 18-20 are pivotally connected to the crankshaft and pivotally connected to second arm 24-26 of the aerating means. Aerating means 21 is shown in FIGS. 2a and 2b. Second arm 24 has a hinge 25 connected to the fourth arm 18, which is connected via a hinge 26 to crankshaft 14 which can rotate around a shaft 27 as according to arrow 28, driven herein by a belt which engages on for instance a toothed wheel 29 of the crankshaft. In another embodiment the rotation is opposite to that of arrow 28, i.e. clockwise.

Through driving of the crankshaft as according to arrow 28 second arm 24 will pivot around pivot point 31 as according to arrow 30. Pivot point 31 is a bearing which is fixedly connected to frame 2. FIG. 1 shows fixed pivot point 32 of arm 25. The second arms of the aerating means are fixedly connected in each case to the frame. In another embodiment the fixed connection is absent and the connection can be movable. A locking which is fixable can be used to fix the pivot point in the situation of use.

Aerating means 21 further comprises a first arm 40. First arm 40 extends substantially parallel to second arm 24. Close to a first outer end 36 of second arm 24 pin holder 38 is connected to the aerating means by means of a hinge 37. The pin holder can pivot around hinge 37 relative to second arm 24 as according to arrow 39.

Pin holder 38 is also connected via a hinge 42 to a first outer end of first arm 40 of the aerating means. In the shown embodiment according to FIG. 2a a parallelogram figure is obtained since the free end 43 of first arm 40 can also pivot around pivot point 44. When crankshaft 15 rotates as according to arrow 28, both the first arm 40 and second arm 24 will pivot as according to arrow 30 and a repetitive movement is performed, wherein pins 45, which are fixedly connected to pin holder 38, will move up and downward as according to arrow 46. The pins are herein inserted into the ground each time. A constantly repetitive movement is performed, wherein the pins are inserted into the ground surface, whereby a certain degree of aeration occurs.

According to a first aspect of the invention, the pivot point 44 close to free end 43 of first arm 40 is movable relative to frame 2 in the situation of use, wherein the crankshaft rotates as according to arrow 28. For this purpose pivot point 44 is connected via a third arm 50 to a suspension 51. In the shown embodiment according to FIG. 2a the third arm 50 is connected to a schematically shown torsion spring 52. Torsion spring 52 connects third arm 50 to the suspension on one side and is fixedly connected on the other to the frame via a schematically shown arm 55. Third arm 50 could pivot around shaft 56 of torsion spring 52 as according to arrow 57. Pivot point 44 can hereby move as according to the same arrow 57.

In the situation of use aerating device 1 moves over the ground surface at a determined speed of movement as according to arrow 60. Owing to this speed of movement the pin 45, which is inserted almost vertically into the ground, cannot retain its vertical position during the continuous movement of the device over the ground as according to arrow 60, but will have to pivot to some extent as according to arrow 61. This is made possible in that pivot point 44 can displace as according to arrow 62 in this situation of use, wherein the aerating device moves according to arrow 60 on the one hand and the crankshaft rotates around shaft 27 as according to arrow 28 on the other. Due to the pivoting of pin 45 according to arrow 61 third arm 50 will pivot slightly in clockwise direction around shaft 56 as according to arrow 57, whereby a torsional stress is built up in torsion spring 52 which will want to return arm 50 to the starting position shown in FIG. 2a. The force generated by the torsion spring provides resistance to the pivoting according to arrow 61 as a result of the movement according to arrow 60.

During use of the aerating device pivot point 44 is thus not fixed or positioned in forced manner but is movable, for instance as according to arrow 62.

FIG. 2a further shows the stop 70 formed by a bush 71 in which is received a bullet-shaped element 73, which is movable according to arrow 72 and which lies with an end surface 74 against third arm 50. Bullet-shaped element 73 is displaceable as according to arrow 72 by means of a rod 75, shown in cross-section, which is mounted eccentrically around shaft 76. The contact point can hereby be displaced as according to arrow 72. FIG. 2b shows a displaced position wherein stop 70 is set to a position more to the left. The adjustment to the left is obtained by rotating rod 75 around eccentric point 76. The stop prevents movement of the pivot point to the right.

Both FIG. 2a and FIG. 2b show a starting position of the pivot point or suspension point 44. The starting position can be adjusted with stop 70. FIG. 2b shows what consequences the displacement of bullet-shaped element 73 to the left has for the adjustment of pin 45. Because pivot point 44 is displaced to the left, the whole first arm 40 is displaced substantially to the left and pin holder 38 is brought into a position out of vertical with an angle α relative to the vertical. The insertion angle of the pin into the ground is hereby changed. When the aerating means is driven with the crankshaft, the pin will be inserted into the ground at the angle a, whereby a different degree of aeration is obtained.

FIG. 2b also shows that second arm 50 is pivoted as according to arrow 57 and is now biased in the shown starting position by torsion spring 52.

When the aerating device is used with a starting position according to FIG. 2b, it will still be possible during movement of the aerating device as according to arrow 60 that during use the pivot point/suspension point 44 can change position and can move as according to arrow 57. Angle a is hereby increased still further, whereby a rooting and aerating movement of pin 45 in the ground is achieved.

In an embodiment the aerating means 21,22,23 are all embodied according to the first embodiment of FIGS. 2a and 2b and are provided in each case with a stop 70 with a bullet-shaped element 73. One rod 75, which is eccentrically rotatable around shaft 76, is incorporated in aerating device 1. All respective stops 70 of the respective aerating means are moved as according to arrow 72 by the rotation of rod 75, and adjustment of all insertion angles of the respective pins 45 of the aerating means is achieved in one operation. This is a particularly simple adjustment of insertion angle α.

Biasing force refers here in all cases to the force necessary to displace the pivot point relative to the frame.

Shaft 56 can also extend over the whole operating width 80 of the aerating device and can be bearing-mounted in side walls 3 of frame 2. Torsion springs 52 of the respective suspensions of the respective aerating means can be coupled to an arm 55. Arm 55 is connected to the frame for pivoting as according to arrow 80, and pivoting of arm 55 will result in a different adjustment of the bias exerted on third arm 50 with torsion spring 52. The torque can be adjusted by rotating arm 55 as according to arrow 80. The spring force exerted on the third arm by torsion spring 52 further depends on for instance the wire thickness of the torsion spring, the spring diameter, centre-to-centre in millimetres, the number of active windings of the torsion spring, the total number of connections, the pitch of the windings, and on the material properties, such as the elastic modulus of the material.

From the starting position shown in FIGS. 2a and 2b a force is required in the direction of arrow 62 before pivot point 44 will be able to move freely relative to the rest of the frame and before the second arm is released from the contact against point 74 of stop 70. This force in fact corresponds with the prior art spring force exerted in a telescopic first arm 40.

The forces differ for FIGS. 2a and 2b since a smaller or greater force is generated by the rotation according to arrow 57 in FIG. 2b compared to FIG. 2a. This depends on the winding direction of the torsion spring.

With the device according to the invention it is possible via arm 55 to adjust and reset the biasing force exerted by the respective torsion springs of the respective aerating means simultaneously for all aerating means in the aerating device. This is particularly advantageous when the desired biasing force must be modified, for instance when the rotation speed of the crankshaft is increased as according to arrow 28, whereby greater centrifugal forces are generated, whereby a greater biasing force is necessary in the direction of stop 70 to prevent the displacement of suspension point 44.

FIG. 3 shows a second embodiment of an aerating means 100. Aerating means 100 is coupled via a fourth arm 101 to a crankshaft 102 which can rotate around shaft 104 as according to arrow 103. Fourth arm 101 is pivotally connected to a second arm 110 of aerating means 100. First arm 105 runs substantially parallel to second arm 110. Second arm 110 is fixedly connected to frame 112 via hinge 111. In addition, first arm 110 is connected to pin holder 114 with hinge 113. Pin holder 114 is connected by means of a hinge 115 to a first pivoting means 116 of first arm 105, while the second free end 117 of first arm 105 is connected via a hinge 118 to a third arm 119 of suspension 120. When crankshaft 102 rotates as according to arrow 103, arm 110 and arm 105 will move substantially according to arrow 121, and pin holder 114 will guide the pins into the ground in a piercing and repetitive movement.

Suspension 120 connects first arm 105 to the frame. Suspension 120 forms a suspension point 118 which is also the pivot point of first arm 105. In the situation of use pivot point 118 and suspension point 118 can move relative to the fixed frame. The movement is herein limited by spring means. Third arm 119 is bearing-mounted on the frame via bearing 125 and on an arm 127 via hinge 126, wherein a spring 128 is arranged between a protrusion 129 arranged fixedly on rod 127 and a carriage 130 movably connected to the frame. Carriage 130 can be moved relative to the frame as according to arrow 131 and can be fixed in the displaced position, for instance by means of a screw 132. The movement according to arrow 131 is guided by slots 133,134. Fixed pins 135,136 fixedly connected to the frame are accommodated in the slots.

By moving the carriage according to arrow 131 the spring 128 is compressed to a greater or lesser extent, whereby a different spring force is exerted on hinge 126. The spring force is transmitted via hinge 125 onto suspension point 118. When carriage 130 is moved to the left as according to arrow 131 a greater force will be transmitted as according to arrow 140 onto suspension point 118. Suspension point 118 however retains the same starting position since fourth arm 119 lies against an end surface 150 of a stop 151 formed by a bullet-shaped element 152 which is received in a bush 153, wherein the bullet-shaped element can move to the left and to the right as according to arrow 154, adjusted herein by a rod 156 which can rotate eccentrically around a shaft 157. By positioning carriage 130 to the left a greater biasing force is exerted as according to arrow 140 on stop 151. The movement of suspension point 118 is hereby made more difficult since a greater force, counter to force 140, is necessary for the displacement of suspension point 118, which could pivot as according to arrow 160. A movement of suspension point 118 to the right is prevented by stop 151.

Comparable to the situation shown in FIG. 2b, stop 151 can be adjusted by means of rods 156, wherein the contact point can be displaced to the left or to the right as according to arrow 154. The insertion angle of the pins and pin holder 114 can hereby be modified. It will be apparent that carriage 130 can be coupled to a plurality of third arms 119 of respective aerating means arranged adjacently of each other over the width 80 of an aerating device 1 according to FIG. 1.

FIG. 4 shows a third embodiment which is comparable to the second embodiment. Third arm 180 can now pivot around shaft 181 as according to arrow 182, wherein a bias is exerted on third arm 180 by spring 183, which is connected adjustably to frame 185. The adjustment can be carried out as shown with a screw connection 186. The operation of the embodiment of FIG. 4 is very similar to that of FIG. 3.

FIG. 5 shows a fourth embodiment. First arm 201 of aerating means 200 has a free outer end 202 which forms a pivot point 203, which is pivotally connected to third arm 204 which connects pivot point 203 to suspension 205. The pivot point is also suspension point. The shaft in the centre of rosta block 230 is the centre of rotation of carriage 210. In the shown embodiment the suspension is formed by a carriage 210 provided with slots 211 and 212, in which are accommodated pins 213,214 provided with bolts 215,216. The pins can be fixed in a determined position by tightening bolts 215,216. A determined position of carriage 210 is hereby reached in which the carriage can pivot as according to arrow 220. The pivoting according to arrow 220 takes place around a central point formed by the centre of rosta block 230. Displacement of carriage 210 therefore results in a displacement of suspension point 203.

Carriage 210 is formed around a rosta block 230. As shown in cross-section in FIG. 5, the rosta block has a rectangular metal beam shape 231, wherein four elastically deformable materials 232-235 are arranged in the corners of the beam. A second beam-like metal rod 240 is received between the four material parts 232-235. Rod 240 can be connected to third arm 204. Material parts 232-235 can preferably comprise a rubber. Tube 240 which is received in tube 231 can be moved relative thereto as according to arrow 242. A deformation of rubber parts 232-235 herein occurs. The forces necessary for the movement 242 of tube 240 relative to tube 231 depend on the material properties of rubber parts 232-235. In the shown position according to FIG. 5 the rosta block 230 is in a rest position, and no biasing force is therefore being exerted on third arm 204.

It will be apparent to the skilled person that a plurality of carriages 210 can be accommodated in aerating device 1 and that a plurality of third arms 204 of the respective aerating means can be connected to the rosta block. It is hereby possible to adjust and vary the biasing force centrally by means of a central adjustment of carriage 210.

Third arm 204 lies in similar manner against a stop 260 with which the insertion angle can be modified.

A great advantage of using a rosta block is the durability of the spring element, and deformation of the rosta block is moreover silent.

Combinations of the different spring means according to the four embodiments are possible.

Although the invention is described on the basis of the preferred embodiments, various other embodiments are possible within the scope of the patent, the scope of protection of which is defined by the appended claims.

1. A device for aerating a ground, comprising a frame provided with moving means for travel of the device over a ground, a crankshaft which is bearing mounted on the frame and which can be coupled to a drive, a number of aerating means connected to the frame and connected to the crankshaft, wherein the aerating means comprises at least one pin which is adapted to perform a repetitive movement in a situation of use, wherein the pin is inserted into the ground, wherein the movement is guided by at least two pivoting arms of the aerating means, wherein at least a first arm of the aerating means has a pivot point which is movable relative to the frame in the situation of use.

2. A device as claimed in claim 1, wherein the pivot point of the first arm is connected to the frame by means of a suspension.

3. A device as claimed in claim 2, wherein the suspension comprises spring means for positioning the pivot point in a starting position.

4. A device as claimed in claim 3, wherein
the suspension comprises a third arm which is connected to the pivot point of the first arm; and
the spring means are connected to the third arm.

5. A device as claimed in claim 4, wherein the spring means comprise a torsion spring.

6. A device as claimed in claim 4, wherein the spring means comprise a “rosta” block.

7. A device as claimed in claim 3 wherein a stop is connected to the frame to define the starting position of the pivot point.

8. A device as claimed in claim 7, wherein the device comprises a means for adjusting the position of the stop relative to the frame.

9. A device as claimed in claim 8, wherein the means for adjusting the position of the stop comprises an eccentric shaft which is pivotally connected to the frame.

10. A device as claimed in claim 7 wherein the spring means comprise a biasing means which is adapted to exert a biasing force in the direction of the stop.

11. A device as claimed in claim 3 wherein the suspension has a number of spring means which are each connected to the first arm of an aerating means, wherein the suspension has an adjusting means for centrally adjusting the spring force.

12. A device as claimed in claim 11, wherein the adjusting means is connected movably and fixably to the frame.

13. A device as claimed in claim 2 wherein the suspension connects a number of first arms of the aerating means to the frame, wherein the pivot points of these first arms are movable relative to the frame in the situation of use.

14. A device as claimed in claim 1 wherein the pivot point is arranged on a free outer end of the first arm.

15. A device as claimed in claim 1 wherein the second arm has a pivot point which is fixedly connected to the frame.

16. A device as claimed in claim 1 wherein a fourth arm is pivotally connected to the crankshaft and to an arm of the aerating means.

17. A device as claimed in claim 1 wherein the first and second arm of the aerating means are substantially parallel arms for the purpose of guiding the movement of the pin.

18. A method for aerating a ground, comprising:
moving a device over the ground, said device comprising:
a frame;
a crankshaft which is bearing mounted on the frame and which can be coupled to a drive;
at least one pin connected to the frame and connected to the crankshaft;
repetitively moving the pin by activating the drive when the crankshaft is coupled to the drive, wherein the pin is inserted into the ground and wherein the movement is guided by at least two pivoting arms mechanically coupled to the pin, and;
moving a pivot point of at least a first arm mechanically coupled to the pin relative to the frame.

19. A method as claimed in claim 18, wherein the pivot point of the first arm is connected to the frame by a suspension.

20. A method as claimed in claim 19, wherein the pivot point is positioned in a starting position by a spring.

21. A method as claimed in claim 20, wherein the suspension comprises a third arm which is connected to the pivot point of the first arm, and the spring is connected to the third arm.

24. A method as claimed in claim 20 wherein a stop is connected to the frame to define the starting position of the pivot point.

25. A method as claimed in claim 24, further comprising adjusting the position of the stop relative to the frame.

26. A method as claimed in claim 25, wherein the position of the stop is adjusted along an eccentric shaft which is pivotally connected to the frame.

27. A method as claimed in claim 24 wherein the spring exerts a biasing force in the direction of the stop.

28. A method as claimed in claim 20 wherein the suspension has a plurality of springs which are connected to the first arm, further comprising centrally adjusting the spring force of the springs.

29. A method as claimed in claim 19 wherein the suspension connects a plurality of first arms to the frame, wherein the pivot points of each of the first arms are moved relative to the frame.

30. A method as claimed in claim 18 wherein the first arm and a second arm are substantially parallel arms that guide the movement of the pin.
